(19) United States
(12) Patent Application Publication
(10) Pub. No.: US 2014/0310493 A1
(43) Pub. Date: Oct. 16, 2014

(54) MIGRATING DATA ACROSS STORAGES WITH DISSIMILAR ALLOCATION SIZES

(71) Applicant: INTERNATIONAL BUSINESS MACHINES CORPORATION, Armonk, NY (US)

(72) Inventor: Richard Grove Pace, Simi Valley, CA (US)

(73) Assignee: International Business Machines Corporation, Armonk, NY (US)

(21) Appl. No.: 13/861,312

(22) Filed: Apr. 11, 2013

(51) Int. Cl. G06F 3/06

(52) U.S. Cl. CPC G06F 3/0647; G06F 3/0604; G06F 3/0683
USPC 711/165

(57) ABSTRACT

A method, system, and computer program product for migrating data across storages with dissimilar allocation sizes are provided in the illustrative embodiments. A determination is made of a minimum allocation unit size used for allocating space to a data at a source data storage device. A number of first minimum allocation units of a first minimum allocation unit size at a target data storage device is computed, wherein the number of first minimum allocation units can be completely occupied by a portion of the data. An amount of data left over after excluding the portion of the data from the data is computed. The portion of the data is migrated to the number of first minimum allocation units at the target. The amount of data left over is migrated to a second number of second minimum allocation units of a second minimum allocation unit size at the target.

### TECHNICAL FIELD

The present invention relates generally to a method, system, and computer program product for moving data in a data processing environment. More particularly, the present invention relates to a method, system, and computer program product for migrating data across storages with dissimilar allocation sizes.

### BACKGROUND

A data storage device (storage device) is any device that is usable for storing data. Some examples of storage devices are hard-disk drives, tape drives, solid-state memories and drives, and optical disks.

A storage device stores data by allocating space for the data in blocks of storage space. Typically, the predetermined size is determined according to the type of storage device, and certain other factors, such as the address size used by an operating system, size of the address space, size of the storage space available to a given data processing system, and a combination of these and many other factors.

For example, some storage devices define a “track” and a corresponding “track size.” Space is allocated to data by allocating a number of tracks for storing the data. Space can be allocated in one-track block size, or by a different number of tracks in the block.

Similarly, some storage devices define a “cylinder” and a corresponding “cylinder size.” Such storage devices allocate space to data by allocating a number of cylinders in a block.

Accordingly, some such storage devices can allocate one portion of their space by blocks of one or more tracks, and another portion of their space according to blocks of one or more cylinders. Different storage devices can use different block sizes for allocating space to data. For example, one storage device may use blocks of n tracks to allocate space for data, and another storage device may use blocks of m tracks to allocate space for data. Furthermore, one storage device may use x cylinders as a block when allocating space, and another storage device may use y cylinders as a block for allocating space. The block that a storage device uses to allocate space to data is called a minimum allocation unit, and the size of the block is called a minimum allocation unit size.

### SUMMARY

The illustrative embodiments provide a method, system, and computer program product for migrating data across storages with dissimilar allocation sizes. An embodiment determines, by a processor at a first data processing system, a minimum allocation unit size used for allocating space to a data at a source data storage device. The embodiment computes, by a processor at a first data processing system, a number of first minimum allocation units of a first minimum allocation unit size at a target data storage device, wherein the number of first minimum allocation units can be completely occupied by a portion of the data. The embodiment computes, by a processor at a first data processing system, an amount of data left over after excluding the portion of the data from the data. The embodiment migrates, by a processor at a first data processing system, the portion of the data to the number of first minimum allocation units at the target. The embodiment migrates, by a processor at a first data processing system, the amount of data left over to a second number of second minimum allocation units of a second minimum allocation unit size at the target.

Another embodiment includes one or more computer-readable tangible storage devices. The embodiment further includes program instructions, stored on at least one of the one or more storage devices, to determine a minimum allocation unit size used for allocating space to a data at a source data storage device. The embodiment further includes program instructions, stored on at least one of the one or more storage devices, to compute a number of first minimum allocation units of a first minimum allocation unit size at a target data storage device, wherein the number of first minimum allocation units can be completely occupied by a portion of the data. The embodiment further includes program instructions, stored on at least one of the one or more storage devices, to compute an amount of data left over after excluding the portion of the data from the data. The embodiment further includes program instructions, stored on at least one of the one or more storage devices, to migrate the portion of the data to the number of first minimum allocation units at the target. The embodiment further includes program instructions, stored on at least one of the one or more storage devices, to migrate the amount of data left over to a second number of second minimum allocation units of a second minimum allocation unit size at the target.

Another embodiment includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to determine a minimum allocation unit size used for allocating space to a data at a source data storage device. The embodiment further includes program instructions, stored on at least one of the one or more storage devices for execution by at least one of the one or more processors via at least one of the one or more memories, to compute a number of first minimum allocation units of a first minimum allocation unit size at a target data storage device, wherein the number of first minimum allocation units can be completely occupied by a portion of the data. The embodiment further includes program instructions, stored on at least one of the one or more storage devices for execution by at least one of the one or more processors via at least one of the one or more memories, to compute an amount of data left over after excluding the portion of the data from the data. The embodiment further includes program instructions, stored on at least one of the one or more storage devices for execution by at least one of the one or more processors via at least one of the one or more memories, to migrate the portion of the data to the number of first minimum allocation units at the target. The embodiment further includes program instructions, stored on at least one of the one or more storage devices for execution by at least one of the one or more processors via at least one of the one or more memories, to migrate the amount of data left over to a second number of second minimum allocation units of a second minimum allocation unit size at the target.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a data migration that can be improved according to an illustrative embodiment;

FIG. 4 depicts a block diagram of another data migration that can be improved according to an illustrative embodiment;

FIG. 5 depicts a block diagram of a process of migrating data across storages with dissimilar allocation sizes in accordance with an illustrative embodiment; and

FIG. 6 depicts a flowchart of a process for migrating data across storages with dissimilar allocation sizes in accordance with an illustrative embodiment.

### DETAILED DESCRIPTION

For illustrating the mechanism of storage management and allocation, consider the example of an IBM 3390 storage device operating in a z/OS operating system environment. (“IBM” and z/OS” are registered trademarks of International Business Machines Corporation, in the United States and in other countries.)

For example, the IBM 3390 geometry defines a “cylinder” equal to 15 tracks. A 3390-9 type device may be defined with any number of cylinders ranging from 1 to 65520. So, in the physical hardware configuration of a storage device, a number of cylinders is specified, whereas, from the z/OS operating system software side, data sets may be allocated at track level.

A 3390-A device type can be configured with more than 65520 cylinders. The number of cylinders physically configured above the 65520 number are configured in blocks of 1113 cylinders. For example, for configuring a 3390-A device with 70000 cylinders, the device is configured with 65520 cylinders, plus, in integral number of cylinders in units of 1113 that will yield at least 70,000 cylinders. In this example case of 70000 cylinders, the hardware will configure 65520+Ceiling(((70000−65520)+1112)/1113])*1113=71085 cylinders, where “Ceiling” function rounds up to the next integer. Adding 1112 rounds the difference of 70000−65520 up, to include the next multiple of 1113.

Then from the z/OS software side, the first 65520 cylinders is the “track managed” area, and the remaining 5565 cylinders above 65520 (relative to 1) is the cylinder managed area. In actual implementations the 3390-A device is configured for much larger capacity such as half tera-byte and tera-byte capacity. For a half-tera byte device the hardware configures 639828 cylinders.

The illustrative embodiments recognize that a need to move, or migrate, data from one storage device to another arises in a data processing environment for a variety of reasons. For example, replacing an old, outdated, or defective data storage device with a newer, larger, or faster data storage device often is a cause for migrating data from the previous data storage device to the replacement data storage device.

In the above example, the previously used data storage device acts as the source data storage device (source) and the replacement data storage device acts as the target data storage device (target) in a data migration. Generally, any data storage device can be a source and any data storage device can be a target within the scope of the illustrative embodiments.

The illustrative embodiments recognize that the source and the target are largely free to select a minimum allocation unit and a corresponding minimum allocation unit size for allocating storage for data. Thus, a data that is to be migrated may be stored on the source using one minimum allocation unit size, and upon migration, may be stored on the target using a different minimum allocation unit size.

The illustrative embodiments recognize that different minimum allocation unit sizes in the source and target data storage device causes significant problems in data migration. For example, assume that a source uses a minimum allocation unit size of fifteen cylinders, and data is stored using 30 cylinders, i.e., by allocating two minimum allocation units to the data. Assume that the data is to be migrated to a target that uses minimum allocation unit of twenty one cylinders. The data that uses 30 cylinders exceeds one minimum allocation unit at the target, and therefore, has to be allocated at least two minimum allocation units at the target. Thus, the target system accommodates the same data in 21*2=42 cylinders.

The illustrative embodiments recognize that the 42−30=12 extra cylinders remain unused and are wasted storage space. In addition to the waste, an application that accessed the data at the source data storage device might read an end-of-file at the end of 30 cylinders when the data is stored at the source, and might read to the end of 42^{nd} cylinder at the target. Consequently, the application may read garbage data in the 12 unused cylinders, causing an error or malfunction.

Alternatively, to stop the application from reading beyond the 30^{th} cylinder in the 42 cylinder allocation, special end-of-file markers may have to be recorded before the unused cylinders. The illustrative embodiments recognize that such an exercise introduces complexity and cost into the data migration process.

As another example, when a source stores data across several volumes, each volume may be migrated separately to the target, causing gaps to occur within the data. For example, assume that volume 1 of a source stores one part of data in 90 cylinders using 15 cylinder minimum allocation units, and volume 2 of the source stores another part of the data in 60 more cylinders using 15 cylinder minimum allocation units. When data from these two volumes is migrated to a target that uses 21 cylinder minimum allocation unit, the first part of the data from volume 1 is stored in 105 (21*5) cylinders, and the second part is stored using 63 cylinders (21*3).

This migration leaves 15 unused blocks within the data, and 3 unused blocks at the end of the data. An application reading the data from the target may encounter problems by reading garbage data from the intervening 15 unused blocks, the 3 trailing unused blocks, or both.

The illustrative embodiments used to describe the invention generally address and solve the above-described problems and other problems related to the data migration in a data processing environment. The illustrative embodiments provide a method, system, and computer program product for migrating data across storages with dissimilar allocation sizes.

The illustrative embodiments further recognize that some data storage devices are capable of using multiple minimum allocation units and minimum allocation unit sizes. For example, a data storage device can allocate space using a minimum allocation unit of one track in one portion of the storage, and a minimum allocation unit of twenty one cylinders in another portion of the storage.

An embodiment utilizes the ability of a data storage device to allocate minimum allocation units of various sizes in different portions of the device to avoid unused space in the migrated data. For example, assume that a target data storage device can allocate space using a large minimum allocation unit size and a small minimum allocation unit size. Only as an example, and without implying a limitation thereto, a block of one track can be regarded as a small minimum allocation unit and a block of twenty one cylinders can be regarded as a large minimum allocation unit.

An embodiment computes the number of large minimum allocation units that can be fully occupied by the data. The embodiment allocates that number of large minimum allocation units to the data. The remaining portion of the data, whether at the beginning, end, or somewhere there-between of the data, that only partially occupies a large minimum allocation unit is allocated space using one or more small minimum allocation units.

The illustrative embodiments are described with respect to certain components of a data processing environment and minimum allocation unit sizes used therein only as examples. Any specific manifestations of such components, such as a data storage device that uses minimum allocation units based on a track or cylinder type basic data organization structures, are not intended to be limiting to the invention. Any suitable minimum allocation unit size or sizes computed using any basic data organization structures can be selected, in any manifestation of a data storage device, within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

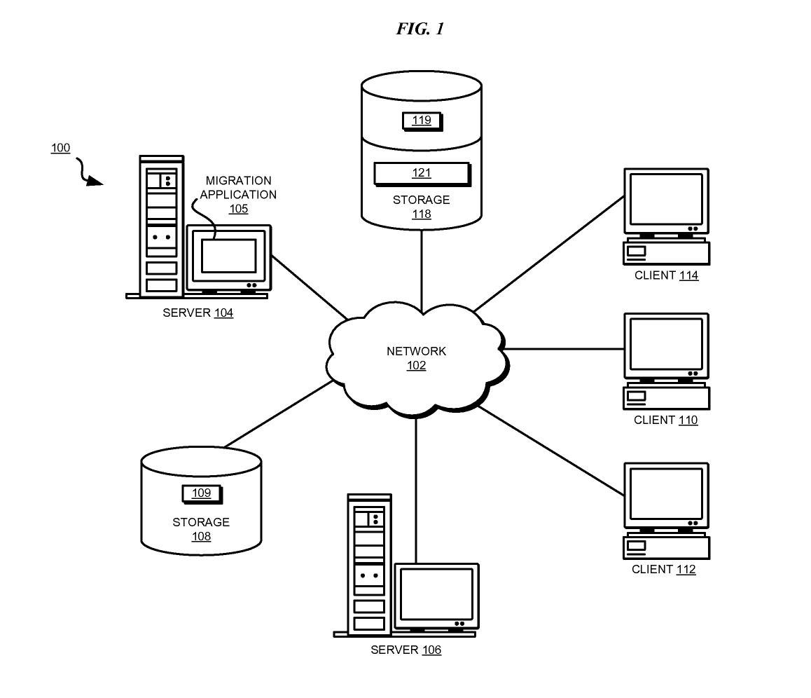

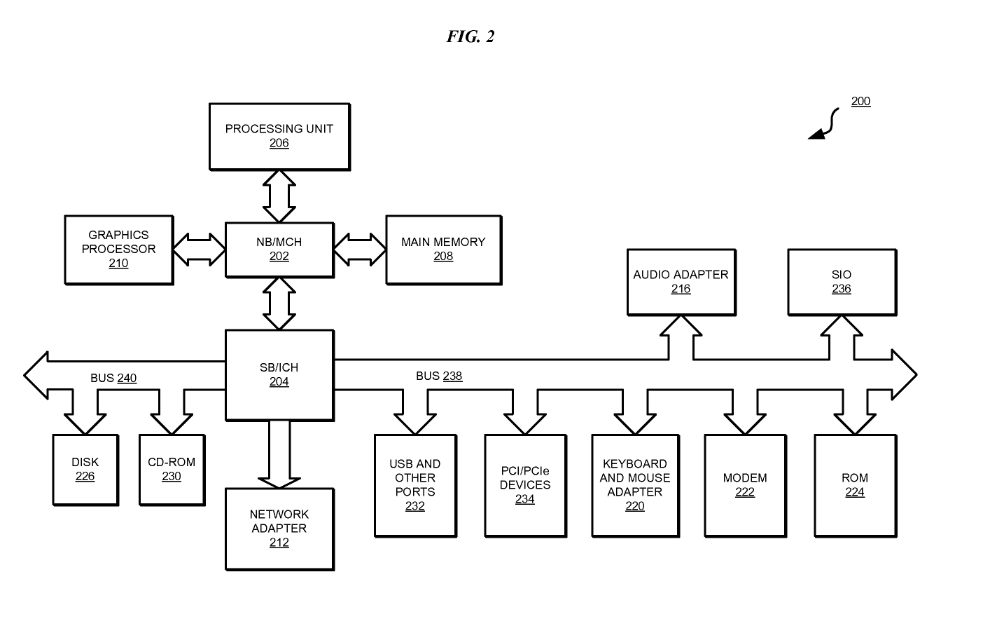

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114, may contain data and may have software applications or software tools executing thereon.

Only as an example, and without implying any limitation to such architecture, FIG. 1 depicts certain components that are usable in an example implementation of an embodiment. For example, storage 108 allocates space using minimum allocation unit 109, which is of a certain minimum allocation unit size. Storage 118 allocates space using minimum allocation unit 119 of a first minimum allocation unit size, and minimum allocation unit 121 of a second minimum allocation unit size. In one embodiment, storage 108 acts as a source, and storage 118 acts as a target. Migration application 105 in server 104 implements an embodiment to migrate data from source storage 108 to target storage 118. In one embodiment, minimum allocation unit 109 and minimum allocation unit 119 are 1 track in size, and minimum allocation unit 121 is 21 cylinders in size.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, files related to the operating system and other software applications, and application features to clients 110, 112, and 114. Clients 110, 112, and 114 may be clients to server 104 in this example. Clients 110, 112, 114, or some combination thereof, may include their own data, boot files, operating system images, files related to the operating system and other software applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 112 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. A computer readable or usable storage device does not include propagation media. Hard disk drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as migration application 105 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

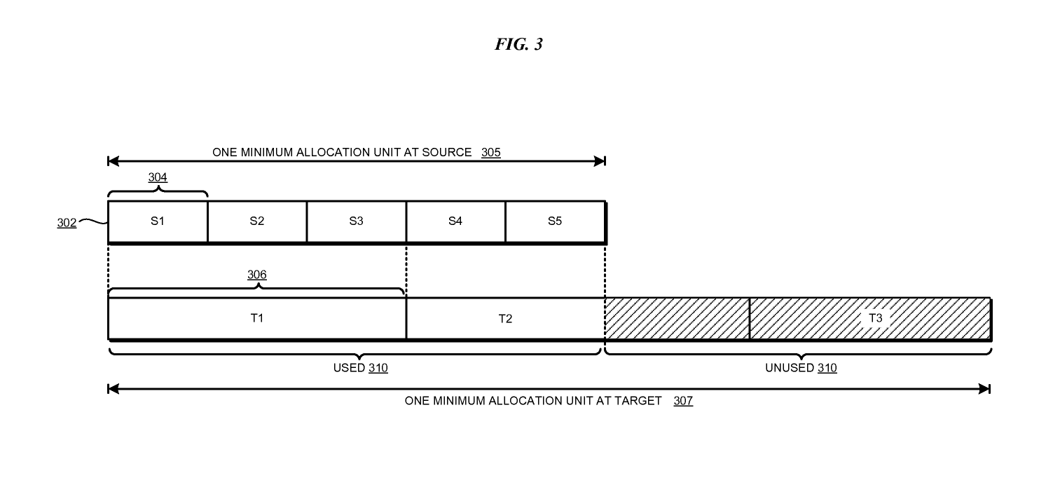

With reference to FIG. 3, this figure depicts a block diagram of a data migration that can be improved according to an illustrative embodiment. Data 302 is shown stored in a source, such as source 108 in FIG. 1, using five example basic data organization structures S1, S2, S3, S4, and S5, each of size 304. Minimum allocation unit 305 is shown to include five basic data organization structures S1-S5 only as an example. Minimum allocation unit 305 may include any number of basic data organization structures S1-Sn, such as tracks or cylinders or a combination thereof, at the source within the scope of the illustrative embodiments. Data 302 is shown to be accommodated in one minimum allocation unit 305 only as an example. Data 302 may span any number of minimum allocation units at the source without limitation in a similar manner.

A target uses basic data organization structures, such as T1, T2, and T3, each of size 306. The target uses minimum allocation unit 307. Minimum allocation unit 307 is shown to include three basic data organization structures T1-T3 only as an example. Minimum allocation unit 307 may include any number of basic data organization structures T1-Tm, such as tracks or cylinders or a combination thereof, at the source within the scope of the illustrative embodiments.

During data migration, a migration application implementing an embodiment, such as migration application 105 in FIG. 1, determines that data 302 can be accommodated in one minimum allocation unit 307 at the target. The migration application recognizes that migrating data 302 from minimum allocation unit 305 to minimum allocation unit 307 will cause space 308 to be used and space 310 to remain unused in minimum allocation unit 307. In this example, unused space 310 appears at the end of data 302 after migration to the target data storage device.

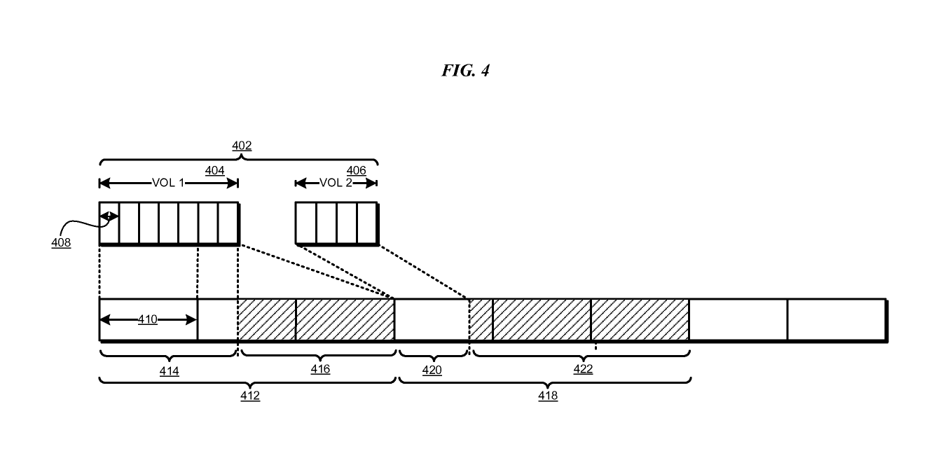

With reference to FIG. 4, this figure depicts a block diagram of another data migration that can be improved according to an illustrative embodiment. Data 402 is similar to data 302 in FIG. 3, and is shown stored in a source, such as source 108 in FIG. 1, using multiple volumes. For example, portion 404 of data 402 is stored in volume 1, and portion 406 of data 402 is stored in volume 2. Portion 404 spans seven example minimum allocation units, each of size 408. Portion 406 similarly spans four example minimum allocation units of size 408.

As an example, assume that the target data storage device uses minimum allocation units, such as minimum allocation units 412 and 418, each comprising three basic data organization structures of size 410 each. A migration process determines that portion 404 can be accommodated in minimum allocation unit 412. Migrating portion 404 to minimum allocation unit 412 causes space 414 to be used, and space 416 to remain unused. Similarly, the migration process determines that portion 406 can be accommodated in minimum allocation unit 418. Migrating portion 406 to minimum allocation unit 418 causes space 420 to be used, and space 422 to remain unused. This multi-volume migration example illustrates the problem of unused spaces intervening data 402 upon migration. An application reading or writing data 402 at the target data storage device after migration can read invalid data from unused space 416, 422, or both, without the benefit of an embodiment.

While the above example describes the problem of intervening unused space after migration, intervening gaps may already be present in volume 1, and may be exacerbated during the migration process. For example, portion 404 in volume 1 may not be a perfect multiple of minimum allocation unit size 408. Consequently, portion 404 may not completely occupy the seven example minimum allocation units, resulting in some unused space in portion 404. This unused space from volume 1 can cause an application error when reading the data in the target even if portion 404 were to perfectly fit a certain number of target minimum allocation units of size 410.

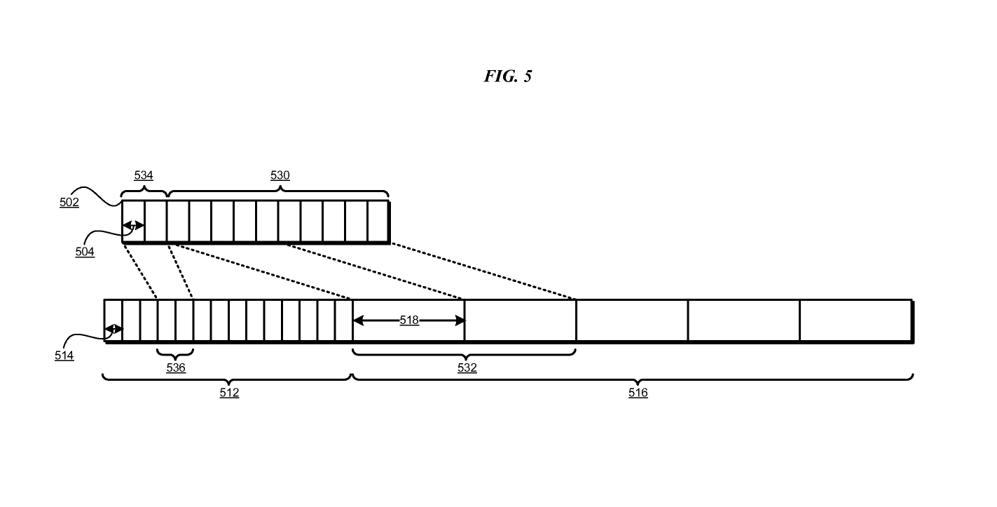

With reference to FIG. 5, this figure depicts a block diagram of a process of migrating data across storages with dissimilar allocation sizes in accordance with an illustrative embodiment. Data 502 is similar to data 402 in FIG. 4, and is stored in a source data storage device, such as storage 108 in FIG. 1.

Data 502 occupies several minimum allocation units at the source, each minimum allocation unit being of size 504 and comprising any number of the basic data organization structures defined for the source. Data 502 is to be migrated to a target data storage device that uses at least two different minimum allocation units of corresponding different minimum allocation unit sizes. For example, in portion 512 of the target, the minimum allocation units are of size 514, and in portion 516 of the target, the minimum allocation units are of size 518. The minimum allocation units in portions 512 and 516 can each comprise any number of basic data organization structures configured in their respective portions of the target data storage device. For the clarity of the description and without implying a limitation, a minimum allocation unit of size 514 will be referred to as a small minimum allocation unit, or minimum allocation unit of a small size. Similarly, for the clarity of the description and without implying a limitation, a minimum allocation unit of size 518 will be referred to as a large minimum allocation unit, or minimum allocation unit of a large size.

An embodiment determines that data 502 as a whole will span more than two large minimum allocation units but will not completely occupy three minimum allocation units. For example, the embodiment computes

t=s mod m

and

c=s−t

Where t is the amount of space needed in the small minimum allocation unit portion, portion 512 of the target; s is the total amount of space needed to store data 502, m is the size of the large minimum allocation unit, i.e., size 518; and c is the amount of large minimum allocation unit space 516 that will be completely occupied by a portion of data 502.

To illustrate the operation of the above computation, assume, for example, that some data occupies 30 cylinders at a source. Further assume that a target uses a large minimum allocation unit of 21 cylinders, and small minimum allocation units of 1 track each. According to the computation described above,

t=30 mod 21

t=9

c=30−9

c=21

Thus, an embodiment determines that the data should be allocated one large minimum allocation unit and a number of small minimum allocation units sufficient to store the remaining 9 cylinders worth of data.

In FIG. 5, operating in a similar manner, an embodiment determines that portion 530 of data 502 can be allocated space 532 in portion 516 of the target, and portion 534 of data 502 can be allocated space 536 in portion 512 of the target. Allocating space in this manner, the embodiment causes the large minimum allocation units to be occupied completely, and managing the remainder of data 502 in target in small minimum allocation units in a manner similar to the management of data 502 in the source.

Because the data migration is often performed in a manner that is non-disruptive to the operations that are using the data, migrating live data can be problematic. To address this problem, an embodiment begins the data migration. If a request for additional allocation for the data arrives at the source during the migration, an embodiment rounds up the request such that the requested allocation would match the large minimum allocation unit of the target data storage device. In this manner, when the additional allocation is migrated, the embodiment migrates a size of data from the source that fits a large minimum allocation unit at the target.

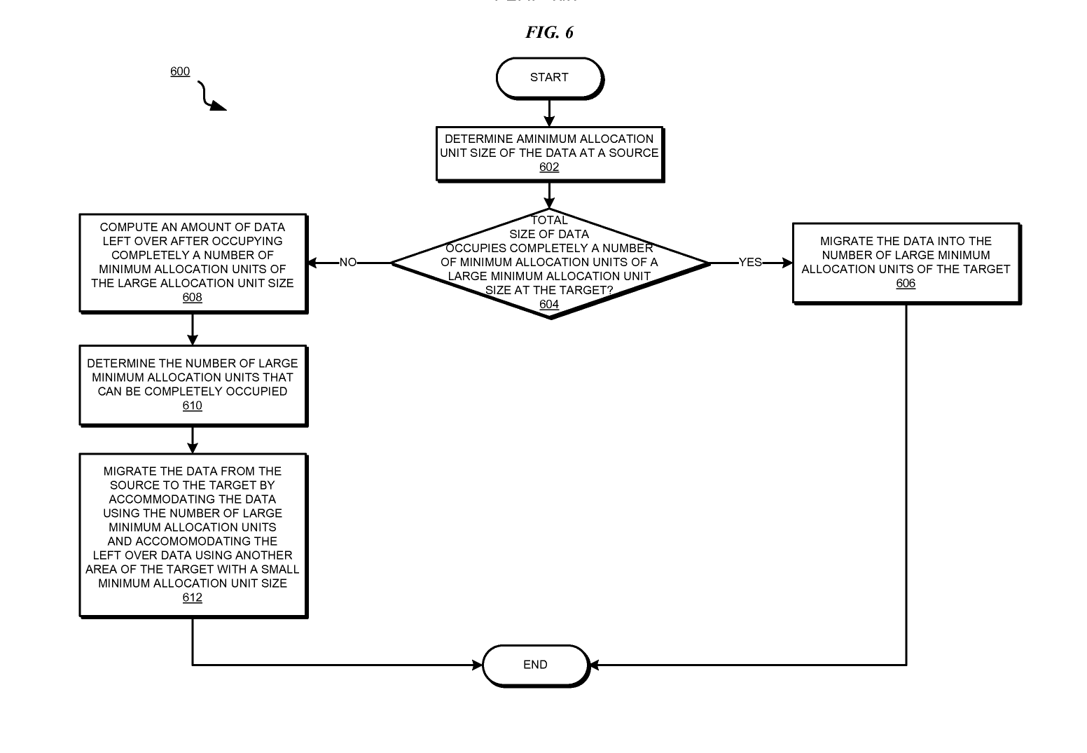

With reference to FIG. 6, this figure depicts a flowchart of a process for migrating data across storages with dissimilar allocation sizes in accordance with an illustrative embodiment. Process 600 can be implemented in a migration application, such as migration application 105 in FIG. 1.

The migration application begins by determining a minimum allocation unit size used for storing the data at a source (step 602). The migration application determines whether the total size of the data occupies completely a number of minimum allocation units of a large minimum allocation unit size at a target data storage device (step 604).

If the data occupies completely a number of minimum allocation units of the large minimum allocation unit size at the target data storage device (“Yes” path of step 604), the migration application migrates the data into the number of large minimum allocation units at the target (step 606). The migration application ends process 600 thereafter.

If the data does not occupy completely a number of minimum allocation units of the large minimum allocation unit size at the target (“No” path of step 604), the migration application computes an amount of data left over after occupying completely a number of minimum allocation units of the large minimum allocation unit size (step 608). The migration application determines a number of large minimum allocation units that can be completely occupied (step 610).

The migration application migrates the data from the source to the target by accommodating the data using the determined number of large minimum allocation units, and accommodating the left over data using one or more minimum allocation units of a small minimum allocation unit size in another area of the target (step 612). The migration application ends process 600 thereafter.

In one embodiment, the small minimum allocation unit size is the same as the minimum allocation unit size used in the source. In another embodiment, process 600 executes non-disruptively while the data is being used from the source. In another embodiment, any future allocation requests for allocating additional space to the data at the source is modified such that a space of the large minimum allocation unit size of the target is allocated at the source in response to the request. Any sizes and numbers of units described in an embodiment are only used as examples without implying a limitation on the illustrative embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for migrating data across storages with dissimilar allocation sizes. An embodiment avoids unused spaces in the post-migration data at the target, without requiring changes to the data to insert special end of data markers.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for migrating data across storages with dissimilar allocation sizes, the method comprising:
determining, by a processor at a first data processing system, a minimum allocation unit size used for allocating space to a data at a source data storage device;
computing, by a processor at a first data processing system, a number of first minimum allocation units of a first minimum allocation unit size at a target data storage device, wherein the number of first minimum allocation units can be completely occupied by a portion of the data;
computing, by a processor at a first data processing system, an amount of data left over after excluding the portion of the data from the data;
migrating, by a processor at a first data processing system, the portion of the data to the number of first minimum allocation units at the target; and
migrating, by a processor at a first data processing system, the amount of data left over to a second number of second minimum allocation units of a second minimum allocation unit size at the target.

2. The method of claim 1, wherein the target allocates a first portion of the target's data storage space in first minimum allocation units of the first minimum allocation unit size, and wherein the target allocates a second portion of the target's data storage space in second minimum allocation units of the second minimum allocation unit size.

3. The method of claim 1, wherein the migrating leaves no unused space in the number of the first minimum allocation units after all the data is migrated to the target.

4. The method of claim 1, further comprising:
migrating, by a processor at a first data processing system, responsive to no amount of the data being left over, the data from the source data storage device into the number of first minimum allocation units at the target data storage device.

5. The method of claim 1, wherein data is non-disruptively migrated from the source to the target while the data is being used at the source, further comprising:
adjusting, by a processor at a first data processing system, a request for additional space allocation for the data at the source.

6. The method of claim 5, wherein the source allocates space according to a source minimum allocation unit size, and wherein the adjusting comprises rounding up the request such that the source allocates an additional space to the data wherein the additional space is of the first minimum allocation unit size.

7. The method of claim 1, wherein the first minimum allocation unit size is a number of cylinders and the second minimum allocation unit size is a number of tracks.

8. The method of claim 1, wherein the second minimum allocation unit size is the same as a source minimum allocation unit size used in storing the data at the source.

9. A computer program product comprising one or more computer-readable tangible storage devices and computer-readable program instructions which are stored on the one or more storage devices and when executed by one or more processors, perform the method of claim 1.

10. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

11. A computer program product for migrating data across storages with dissimilar allocation sizes, the computer program product comprising:
one or more computer-readable tangible storage devices;
program instructions, stored on at least one of the one or more storage devices, to determine a minimum allocation unit size used for allocating space to a data at a source data storage device;
program instructions, stored on at least one of the one or more storage devices, to compute a number of first minimum allocation units of a first minimum allocation unit size at a target data storage device, wherein the number of first minimum allocation units can be completely occupied by a portion of the data;
program instructions, stored on at least one of the one or more storage devices, to compute an amount of data left over after excluding the portion of the data from the data;
program instructions, stored on at least one of the one or more storage devices, to migrate the portion of the data to the number of first minimum allocation units at the target; and
program instructions, stored on at least one of the one or more storage devices, to migrate the amount of data left over to a second number of second minimum allocation units of a second minimum allocation unit size at the target.

12. The computer program product of claim 11, wherein the target allocates a first portion of the target's data storage space in first minimum allocation units of the first minimum allocation unit size, and wherein the target allocates a second portion of the target's data storage space in second minimum allocation units of the second minimum allocation unit size.

13. The computer program product of claim 11, wherein the program instructions, stored on at least one of the one or more storage devices, to migrate leaves no unused space in the number of the first minimum allocation units after all the data is migrated to the target.

14. The computer program product of claim 11, further comprising:
program instructions, stored on at least one of the one or more storage devices, to migrate responsive to no amount of the data being left over, the data from the source data storage device into the number of first minimum allocation units at the target data storage device.

15. The computer program product of claim 11, wherein data is non-disruptively migrated from the source to the target while the data is being used at the source, further comprising:
program instructions, stored on at least one of the one or more storage devices, to adjust a request for additional space allocation for the data at the source.

16. The computer program product of claim 15, wherein the source allocates space according to a source minimum allocation unit size, and wherein the adjusting comprises rounding up the request such that the source allocates an additional space to the data wherein the additional space is of the first minimum allocation unit size.

17. The computer program product of claim 11, wherein the first minimum allocation unit size is a number of cylinders and the second minimum allocation unit size is a number of tracks.

18. The computer program product of claim 11, wherein the second minimum allocation unit size is the same as a source minimum allocation unit size used in storing the data at the source.

19. A computer system for migrating data across storages with dissimilar allocation sizes, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to determine a minimum allocation unit size used for allocating space to a data at a source data storage device;
program instructions, stored on at least one of the one or more storage devices for execution by at least one of the one or more processors via at least one of the one or more memories, to compute a number of first minimum allocation units of a first minimum allocation unit size at a target data storage device, wherein the number of first minimum allocation units can be completely occupied by a portion of the data;
program instructions, stored on at least one of the one or more storage devices for execution by at least one of the one or more processors via at least one of the one or more memories, to compute an amount of data left over after excluding the portion of the data from the data;
program instructions, stored on at least one of the one or more storage devices for execution by at least one of the one or more processors via at least one of the one or more memories, to migrate the portion of the data to the number of first minimum allocation units at the target; and
program instructions, stored on at least one of the one or more storage devices for execution by at least one of the one or more processors via at least one of the one or more memories, to migrate the amount of data left over to a second number of second minimum allocation units of a second minimum allocation unit size at the target.

20. The computer system of claim 19, wherein the target allocates a first portion of the target's data storage space in first minimum allocation units of the first minimum allocation unit size, and wherein the target allocates a second portion of the target's data storage space in second minimum allocation units of the second minimum allocation unit size.
